(19) United States
(12) Patent Application Publication
(10) Pub. No.: US 2021/0362866 A1
(43) Pub. Date: Nov. 25, 2021

(54) Unmanned Aerial Vehicle Power System for Minimizing Propulsion Failure

(71) Applicant: Shanghai Autoflight Co., Ltd., Shanghai (CN)

(72) Inventor: Yu Tian, Hong Kong SAR (CN)

(21) Appl. No.: 17/396,741

(22) Filed: Aug. 8, 2021

Related U.S. Application Data
(63) Continuation-in-part of application No. 16/281,020, filed on Feb. 20, 2019, now abandoned.

(30) Foreign Application Priority Data
Aug. 7, 2020 (CN) 202021632736.8
Oct. 29, 2020 (CN) 202022448141.3

(51) Int. Cl. B64D 31/10; B64C 39/02; B64C 11/46; B64D 27/24; B64D 27/04

(52) U.S. Cl. CPC B64D 31/10; B64C 39/024; B64D 2027/026; B64D 27/24; B64D 27/04; B64C 11/46

(57) ABSTRACT

A UAV and its power system, and a system for minimizing UAV failure. The UAV power system has a propulsion propeller, which is arranged at the rear end of the UAV; the traction propeller which is arranged at the front end of the UAV; either the traction propeller or the propulsion propeller is the main propeller while the other is the backup one; when the UAV is in the level flight stage, at least one of the traction propeller and the propulsion propeller is in the working state; and the driving component which is used to drive the propulsion propeller and the traction propeller. The UAV power system provided by the disclosure is provided with a traction propeller and a propulsion propeller, respectively, to improve the failure redundancy and reduce the safety deficiency of the probability of common mode failure (CMF).

### FIELD OF THE DISCLOSURE

The disclosure relates to UAV technology, in particular to a UAV and its power system and a system for minimizing UAV propulsion failure.

### BACKGROUND OF THE DISCLOSURE

Unmanned aerial vehicle, referred to as “UAV”, is an unmanned aerial vehicle operated by radio remote control equipment and self-contained program control device, or operated completely or intermittently by on-board computer. The common mode failure redundancy in the power of the existing heavy-duty vertical takeoff and landing (VTOL) aerial UAV in the conversion and level flight stages leads to insufficient safety.

### SUMMARY OF THE DISCLOSURE

The disclosure relates to a UAV, its power system and a system for minimizing UAV failure, which is used to solve the problem of insufficient common mode failure safety redundancy.

The disclosure provides a UAV power system, comprising:

The propulsion propeller, which is arranged at the rear end of the UAV;

The traction propeller, which is arranged at the front end of the UAV; either the traction propeller or the propulsion propeller is the main propeller, while the other is the backup one. When the UAV is in the level flight stage, at least one of the traction propeller and the propulsion propeller is in the working state;

And the driving component, which is used to drive the propulsion propeller and the traction propeller.

In an embodiment of the disclosure, the driving component comprises an electric motor and a fuel engine, the motor is used to drive either the propulsion propeller or the traction propeller, and the fuel engine is used to drive the other one of the push propeller or the traction propeller.

An embodiment of the disclosure also includes a plurality of lift propellers, and the lift propellers are driven by the electric motor or the fuel engine.

In an embodiment of the disclosure, the rotation axis of the propulsion propeller is parallel to the length direction of the UAV, and the rotation axis of the traction propeller is parallel to the length direction of the UAV; the rotation axis of the lift propeller is arranged in a vertical direction.

The disclosure also provides a vertical take-off and landing (TVOL) aerial UAV, comprising:

Left main wing and right main wing;

Left front wing and right front wing;

The main body engaged with the left main wing and the right main wing;

The left linear support connecting the left main wing with the left front wing, the left linear support having the first group of a plurality of lift propellers arranged thereon;

The right linear support connecting the right main wing with the right front wing, the right linear support having the second group of a plurality of lift propellers arranged thereon;

The propulsion propeller, which is arranged at the rear end of the main body, with its rotation axis parallel to the longitudinal axis of the UAV;

The traction propeller, which is arranged at the front end of the main body, with its rotation axis parallel to the longitudinal axis of the UAV;

In an embodiment of the disclosure, either the propulsion propeller or the traction propeller is driven by an electric motor and the other is driven by a fuel engine.

In an embodiment of the disclosure, the propulsion propeller is driven by the fuel engine.

In an embodiment of the disclosure, when the aerial UAV is in the low altitude conversion mode or cruise mode, the fuel engine is in the idle state.

In an embodiment of the disclosure, it also includes a starting motor, which is engaged with the fuel engine through a physically driven clutch device.

In an embodiment of the disclosure, during the operation of the fuel engine, the starting motor can maintain mechanical engagement with the fuel engine. In an embodiment of the disclosure, it also includes a detachable cabin attached to the bottom surface of the aerial UAV.

In an embodiment of the disclosure, the cabin is a passenger cabin or a cargo hold.

In an embodiment of the disclosure, the fuel engine is a vehicle gasoline piston aero-engine.

The disclosure also provides a system for minimizing the failure of an aerial UAV, comprising:

Left main wing and right main wing;

Left front wing and right front wing;

The main body engaged with the left main wing and the right main wing;

The left linear support connecting the left main wing with the left front wing;

The right linear support connecting the right main wing with the right front wing;

The propulsion propeller arranged at the rear end of the main body, with its rotation axis parallel to the longitudinal axis of the UAV;

The traction propeller arranged at the front end of the main body, with its rotation axis parallel to the longitudinal axis of the UAV;

The first group of a plurality of lift propellers arranged on the left linear support;

The second group of a plurality of lift propellers arranged on the right linear support;

The fuel engine configured to drive either of a plurality of lift propellers, the propulsion propellers and the traction propellers; and

The electric motor configured to drive at least one of a plurality of the lift propellers, the propulsion propeller and the traction propeller.

In an embodiment of the disclosure, the propulsion propeller is driven by the fuel engine.

In an embodiment of the disclosure, it also includes a starting motor engaged with the fuel engine.

In an embodiment of the disclosure, it also includes a generator engaged with the fuel engine.

In an embodiment of the disclosure, during flight, the starting motor maintains mechanical engagement with the fuel engine for power generation.

In an embodiment of the disclosure, it also includes a cabin detachably attached to the bottom surface of the aerial UAV.

In an embodiment of the disclosure, the cabin is a passenger cabin or a cargo hold.

The disclosure provides a UAV power system, which comprises a propulsion propeller, which is arranged at the rear end of the UAV; a traction propeller arranged at the front end of the UAV; either the traction propeller or the propulsion propeller is the main propeller and the other is the backup one. When the UAV is in the level flight stage, at least one of the traction propeller and the propulsion propeller is in the working state; a driving component for driving the propulsion propeller and the traction propeller. The UAV power system provided by the disclosure is provided with a traction propeller and the propulsion propeller, respectively. When the traction propeller or the propulsion propeller fails, the other one can continue to work to enable the UAV to fly forward, thereby improving the failure redundancy and reducing the safety deficiency of common mode failure probability.

The disclosure provides an aerial VTOL UAV, which comprises left main wing and right main wing; left front wing and right front wing; main body engaged with the left main wing and the right main wing; left linear support connecting the left main wing with the left front wing; right linear support connecting the right main wing with the right front wing; the propulsion propeller arranged at the rear end of the main body, with its rotation axis parallel to the longitudinal axis of the UAV; the traction propeller arranged at the front end of the main body, with its rotation axis parallel to the longitudinal axis of the UAV; wherein the left linear support has the first group of a plurality of lift propellers arranged thereon; wherein the right linear support has the second group of a plurality of lift propellers arranged thereon. The Aerial VTOL UAV provided by the disclosure is equipped with the traction propeller and the propulsion propeller, respectively, and adopts the multi-mode power configuration to improve the failure redundancy and reduce the safety deficiency of the common mode failure probability.

Although the specifications contain many details of specific implementations, they should not be interpreted as limitations on any disclosure or the scope of protection that can be claimed, but as a description of the characteristics of specific implementations for specific embodiments. Some characteristics described in the context of different implementations in the specifications may also be combined in separate implementations. On the contrary, various characteristics described in the context of separate implementations may also be implemented in multiple implementations alone or in any suitable sub-combination. Further, although characteristics may be described as functioning in certain combinations and even initially in the context, in some cases, one or more characteristics from the described/claimed combination may be removed from the combination, and the described/claimed combination may be a sub-combination or a change to the sub-combination.

Many implementations have been described. However, it should be understood that various modifications may be made without departing from the spirit and scope of the disclosure. For example, the example operations, methods, or processes described herein may include more or less steps than those described. In addition, the steps in these example operations, methods, or processes may be performed in a different manner than those described or shown in the drawings.

Details of one or more implementations of the subject matter described in the disclosure are described in the drawings and the following description. Other characteristics, aspects and advantages of the subject matter will become apparent according to the specifications, drawings and technical solution.

### BRIEF DESCRIPTION OF THE DRAWINGS

It should be noted that the drawings may be in a simplified form and may not be shown in an accurate scale. With reference to the disclosure herein, for convenience and clarity only, and with reference to the drawings, directional terms such as top, bottom, left, right, up, down, upward, above, downward, below, rear, front, distal and proximal are used. These directional terms should not be interpreted as limiting the scope of the embodiments in any way.

FIG. 1a is a top perspective view of an embodiment of a VTOL UAV system according to one aspect of the embodiment;

FIG. 1b is a top perspective view of an embodiment of a VTOL UAV system according to another aspect of the embodiment;

FIG. 1c is a top perspective view of an embodiment of a VTOL UAV system according to the other aspect of the embodiment;

FIG. 2 is a top rear perspective view of the UAV system of FIG. 1c;

FIG. 3 is a side view of the UAV system of FIG. 1c;

FIG. 4 is a top perspective view of another embodiment of a VTOL UAV system with a flight platform and a detachable attached cabin according to one aspect of the embodiment;

FIG. 5 is a top view of the UAV system of FIG. 4 according to one aspect of the embodiment;

FIG. 6 is a front view of the UAV system of FIG. 4 according to one aspect of the embodiment;

FIG. 7 is a top perspective view of an embodiment of a VTOL UAV system with a flight platform and a detachable attached cabin according to one aspect of the embodiment;

FIG. 8 is a front view of the UAV system of FIG. 7 according to one aspect of the embodiment;

FIG. 9 is a rear perspective view of the UAV system of FIG. 7 according to one aspect of the embodiment;

FIG. 10 is a side perspective view of the UAV system of FIG. 7 according to one aspect of the embodiment, wherein the passenger cabin is separated from the flight platform and parked on the ground;

FIG. 11 is a rear perspective view of the embodiment of FIG. 7 according to one aspect of the embodiment;

FIG. 12 is a rear perspective view of another embodiment according to one aspect of the disclosure;

FIG. 13 is a side bottom perspective view of another embodiment of a UAV system according to one aspect of the embodiment;

FIG. 14 is a perspective view of an embodiment of a UAV system according to another aspect of the embodiment;

FIG. 15 is a close-up view of the surrounding area in FIG. 14 according to another aspect of the embodiment;

FIG. 16 is a side view of one embodiment of a UAV system according to another aspect of the embodiment;

FIG. 17 is a front view of one embodiment of a UAV system according to another aspect of the embodiment;

FIG. 18 is a rear view of one embodiment of a UAV system according to another aspect of the embodiment;

FIG. 19 is a bottom view of one embodiment of a UAV system according to another aspect of the embodiment;

FIG. 20 is a perspective view of another embodiment of a flight platform according to another aspect of the embodiment;

FIG. 21 is a side view of another embodiment of a flight platform according to another aspect of the embodiment;

FIG. 22 is a front view of another embodiment of a flight platform according to another aspect of the embodiment;

FIG. 23 is a rear view of another embodiment of a flight platform according to another aspect of the embodiment;

FIG. 24 is a bottom view of another embodiment of a flight platform according to another aspect of the embodiment;

FIG. 25 is a side view of another embodiment of a passenger cabin according to another aspect of the embodiment;

FIG. 26 is a bottom perspective view of another embodiment of a passenger cabin according to another aspect of the embodiment;

FIG. 27 is a front view of another embodiment of a passenger cabin according to another aspect of the embodiment;

FIG. 28 is a rear view of another embodiment of a passenger cabin according to another aspect of the embodiment;

FIG. 29 is a bottom view of another embodiment of a passenger cabin according to another aspect of the embodiment;

FIG. 30 is a side view of another embodiment of a flight platform attached to a cargo hold according to another aspect of the embodiment;

FIG. 31 is a perspective view of another embodiment of a flight platform without a propulsion propeller according to another aspect of the embodiment;

FIG. 32 is a side view of another embodiment of a passenger cabin having a propulsion propeller according to another aspect of the embodiment;

FIG. 33 is a perspective view of another embodiment of a flying UAV system in which six floating devices are inflated;

FIG. 34 is a side view of the flying UAV of FIG. 33;

FIG. 35 is a diagram showing the configuration of an aileron of a UAV.

When referring to the elements of the reference signs, in all the drawings of the specifications, the same components are represented by the same reference signs:
100—UAV; 101—Flight platform; 102—Main body; 103A—Left linear support; 103B—Right linear support; 104A—Left main wing; 104B—Right main wing; 105A—Left front wing; 105B—Right front wing; 106A—Left vertical stabilizer; 106B—Right vertical stabilizer; 107—Propulsion propeller; 107A—Left propulsion propeller; 107B—Right propulsion propeller; 108A—First lift propeller; 108B—Second lift propeller; 108C—Third lift propeller; 108D—Fourth lift propeller; 108E—Fifth lift propeller; 108F—Sixth lift propeller; 109A—Left wingtip propeller; 109B—Right wingtip propeller; 110A—Left wingtip vertical stabilizer; 110B—Right wingtip vertical stabilizer; 111A—Left folding leg; 111B—Right folding leg; 112A—First spring leaf; 112B—Second spring leaf; 112C—Third spring leaf; 112D—Fourth spring leaf; 116—Vertical extender; 117—Central propulsion propeller; 130—Cargo hold; 135a—First cabin spring leaf; 135B—Second cabin spring leaf; 135C—Third cabin spring leaf; 135D—Fourth cabin spring leaf; 140—Passenger cabin; 145A—Cabin leg; 145B—Cabin leg; 145C—Cabin leg; 145D—Cabin leg; 147—Cabin attachment latch; 148—Electric wheel; 149—Housing; 150—Energy storage unit in the flight platform; 155—In-cabin energy storage unit; 160—Floating device; 170—Traction propeller; 180—Aileron; 190A—Left additional lift propeller; 190B—Right additional lift propeller; 191A—Left caudal fin; 191B—Right caudal fin.

### DESCRIPTION OF THE PREFERRED EMBODIMENTS

Now, by turning to the detailed description of the following embodiments, we may better understand different aspects of various embodiments, which are presented as illustrative examples of the embodiments defined in the technical solution. It is clearly understood that the embodiments defined by the technical solution may be wider than the illustrated embodiments described below.

The terms used to describe various embodiments in the specifications shall be understood as not only having the meaning of their common definitions, but also including special definitions in the structure, material or behavior in the specifications that are beyond the meaning of the usual definitions. Therefore, if an element can be understood to include more than one meaning in the context of the specifications, its use in the technical solution must be understood to be common to all possible meanings supported by the specifications and the terms themselves.

The term “UAV” is defined as a flight transportation system with at least one propeller as a propulsion source. The term “UAV” may include “manned” and “unmanned” flight transport systems. Manned UAV may refer to a flight transportation system, which carries human passengers who have no control over UAV. Manned UAV may also refer to a flight transportation system that carries human passengers, some or one of which have or has some control over the UAV.

For example, in the background of the disclosure, the common mode failure redundancy security of the existing heavy-duty VTOL UAV in the conversion and level flight stages is insufficient. In order to solve the above problems, the disclosure provides a UAV power system, which comprises a propulsion propeller arranged at the rear end of the UAV; a traction propeller arranged at the front end of the UAV; either the traction propeller or the propulsion propeller is the main propeller while the other is the backup one. When the UAV is in level flight stage, at least one of the traction propeller and the propulsion propeller is in working state; and the driving component which is used to drive the propulsion propeller and the traction propeller. The UAV power system provided by the disclosure is provided with a traction propeller and a push propeller, respectively, at the front end and the rear end of the UAV. When either the traction propeller or the propulsion propeller fails, the other can enable the UAV to continue to fly forward, thereby improving the failure redundancy of the UAV and reducing the safety risk of the UAV.

The technical solution of the disclosure is described in detail below in combination with the specific drawings.

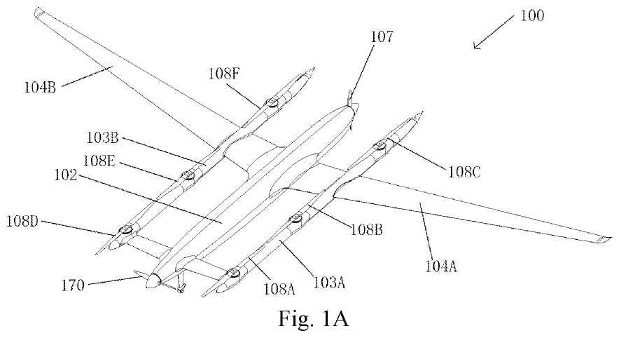

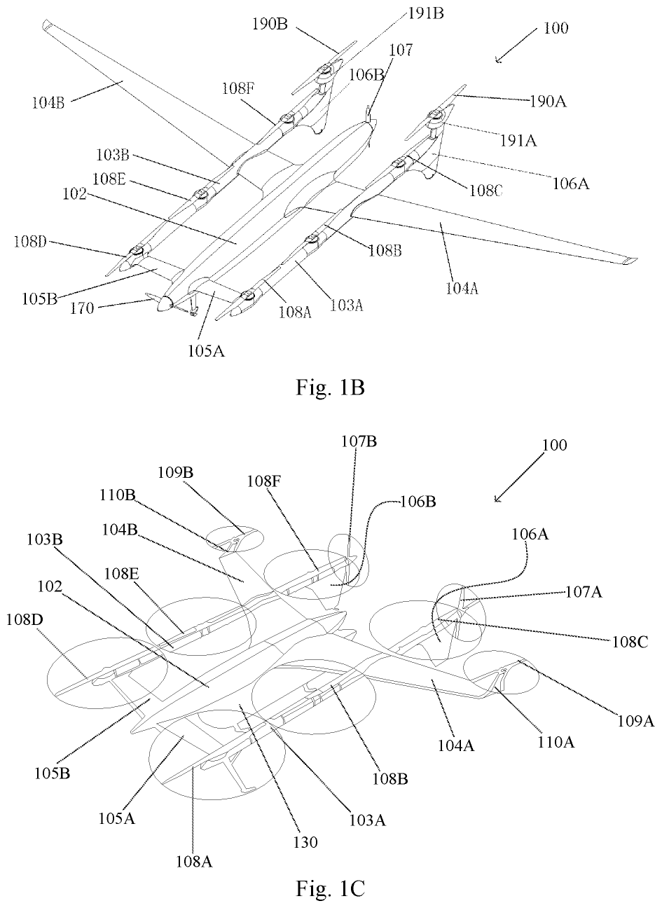

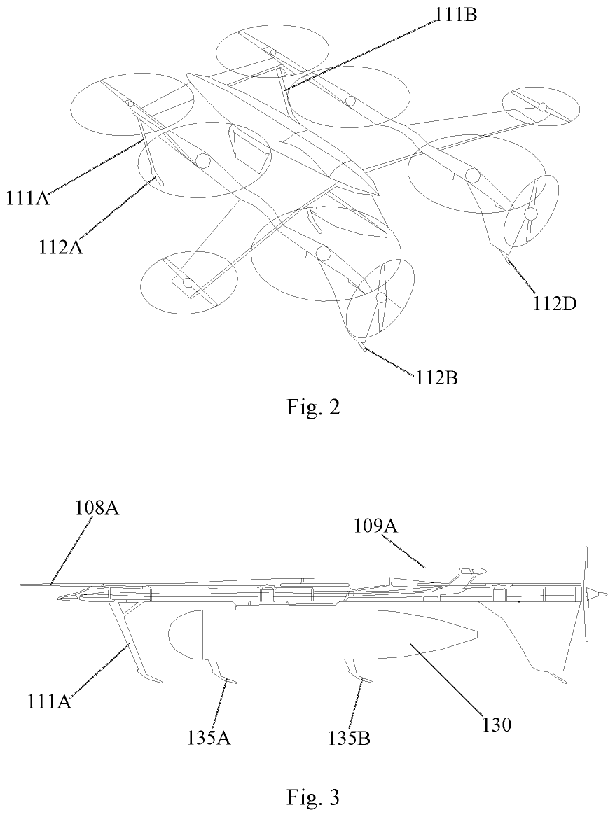

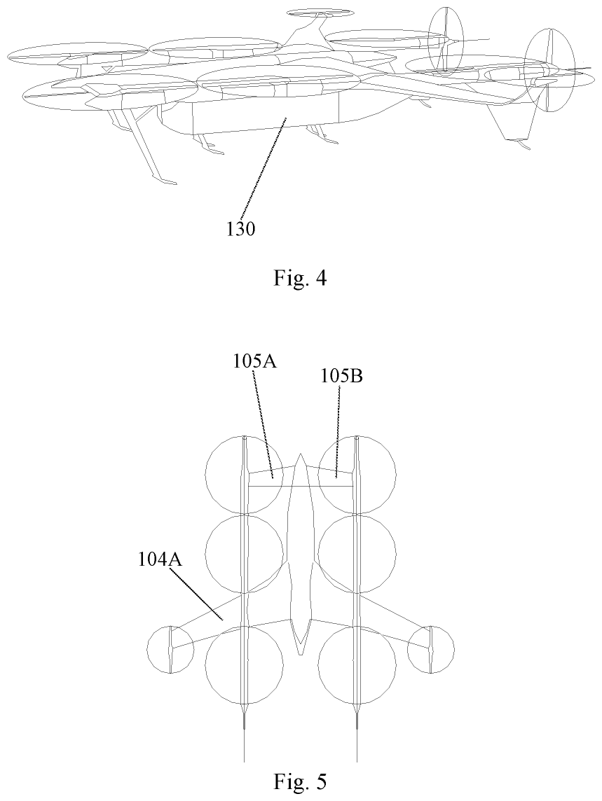

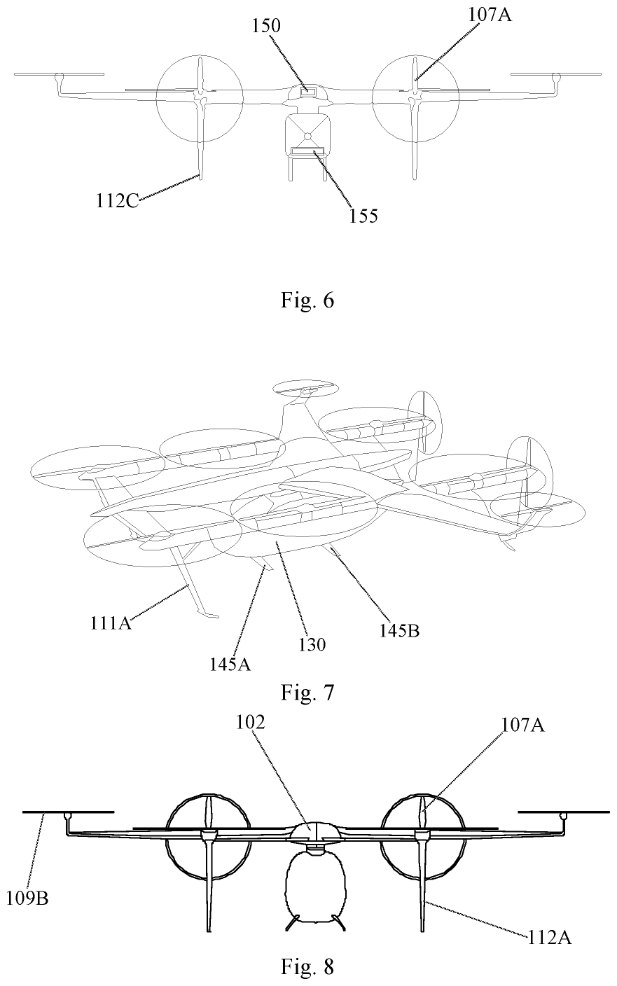

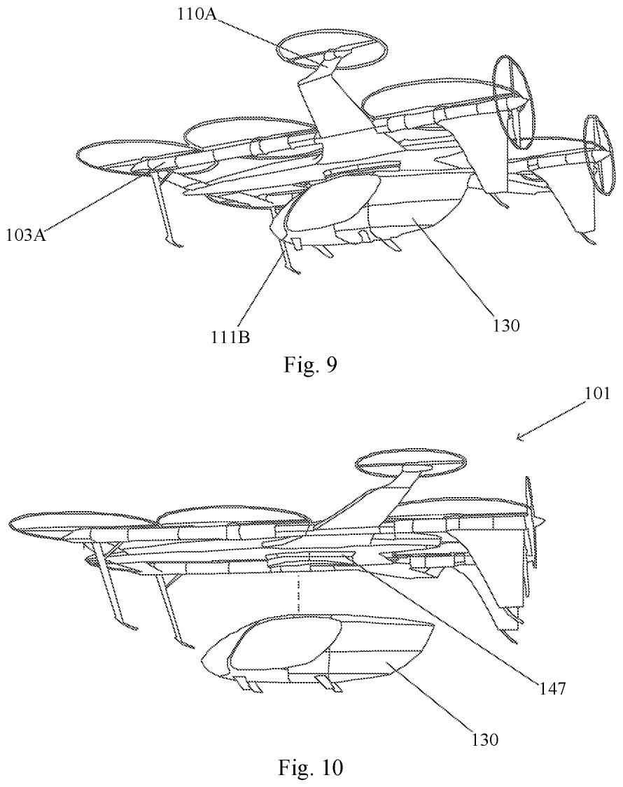

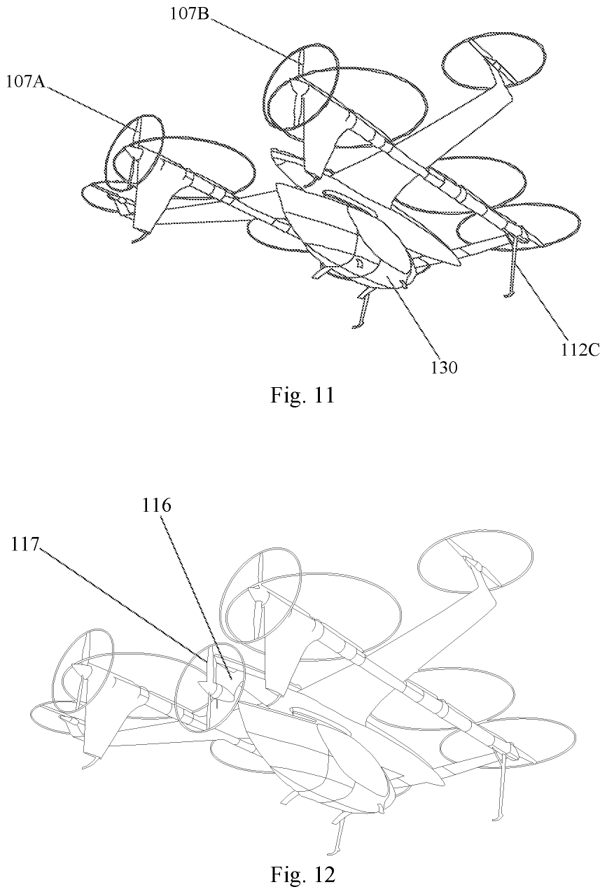

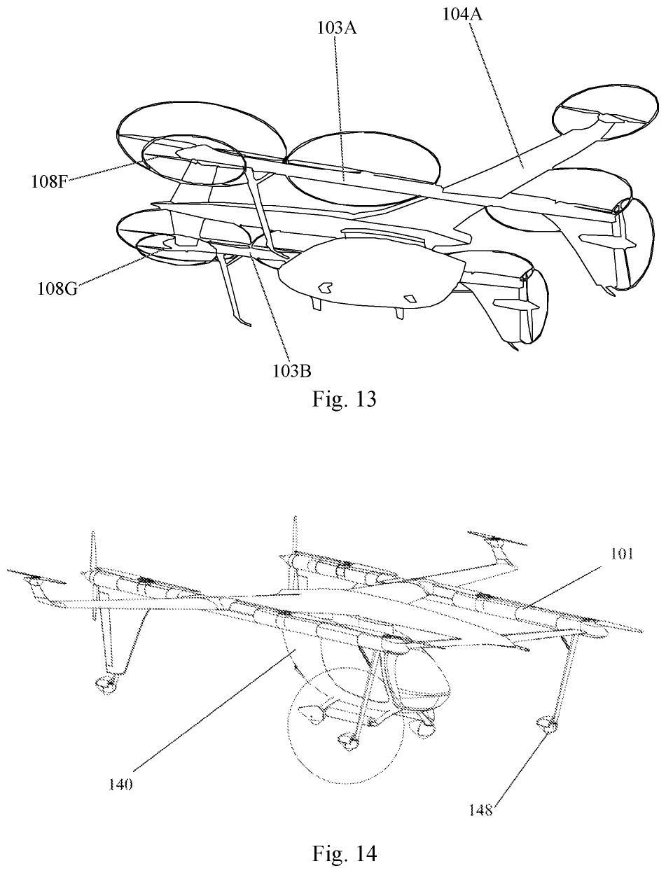

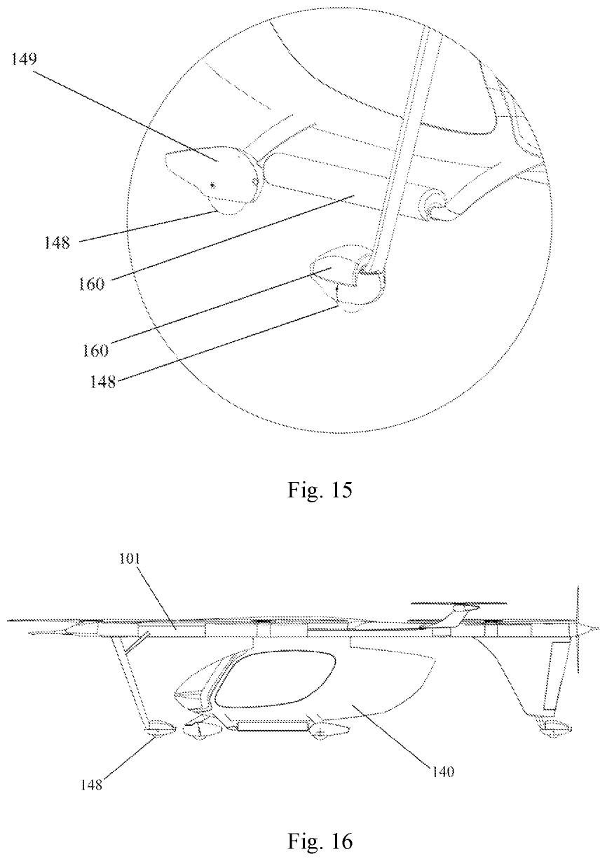

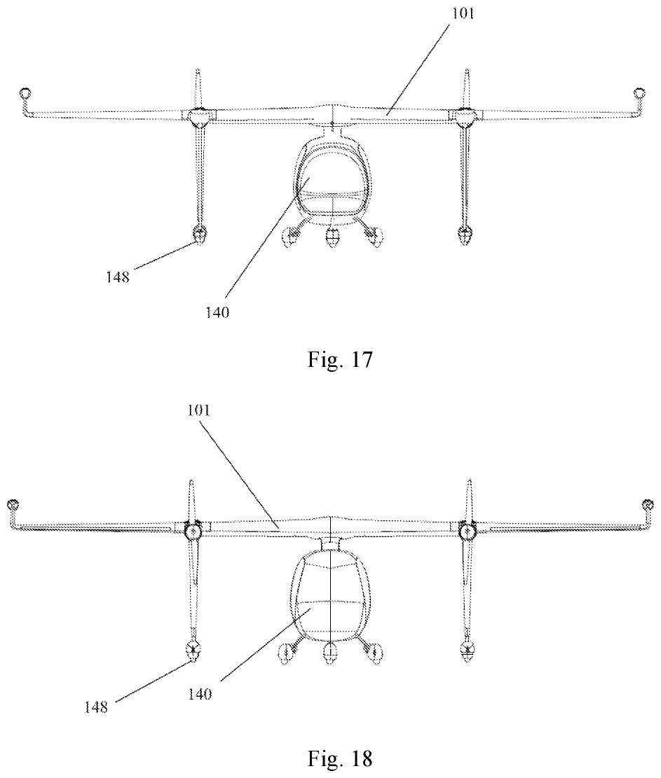

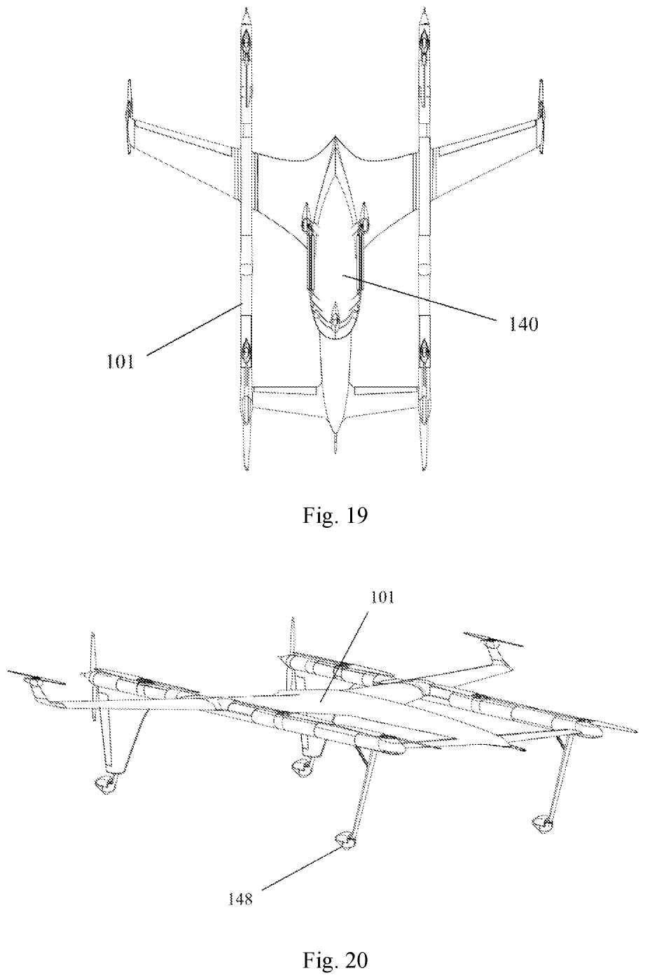

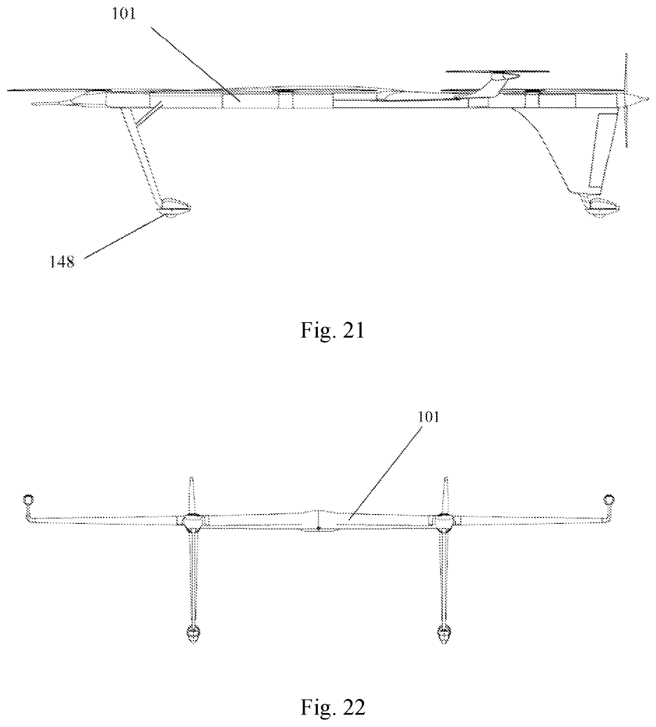

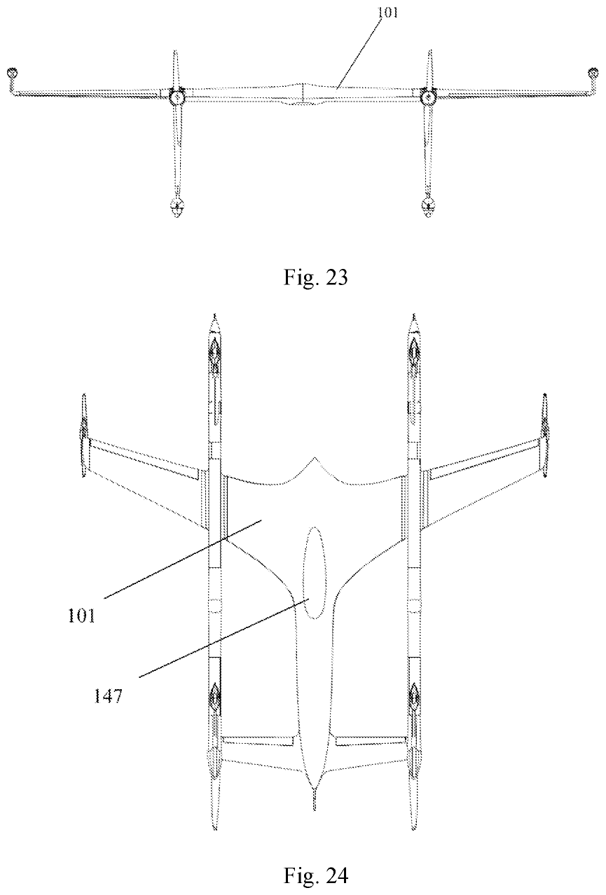

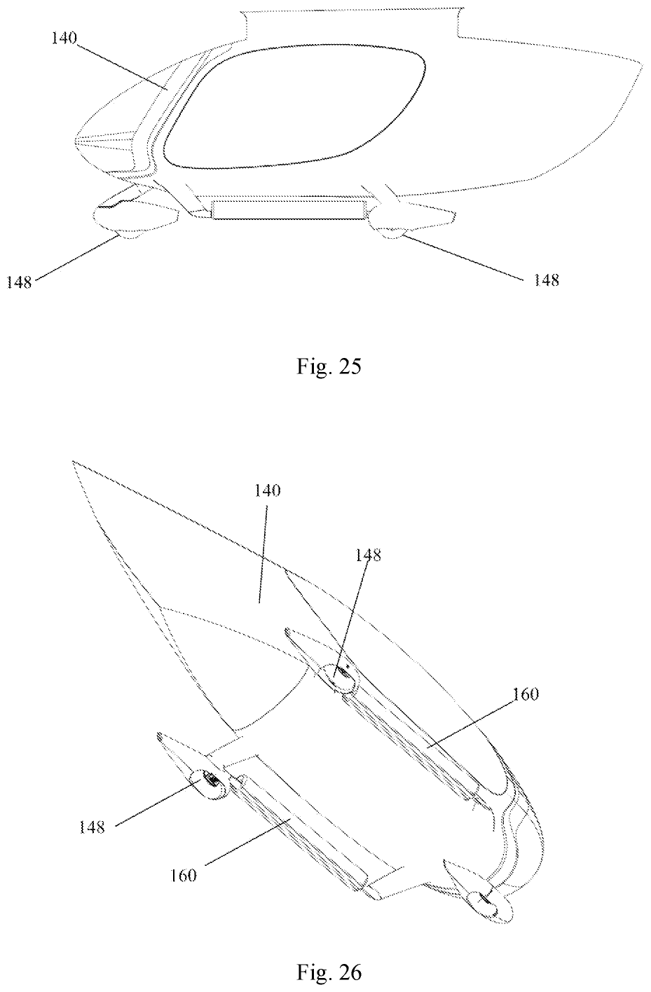

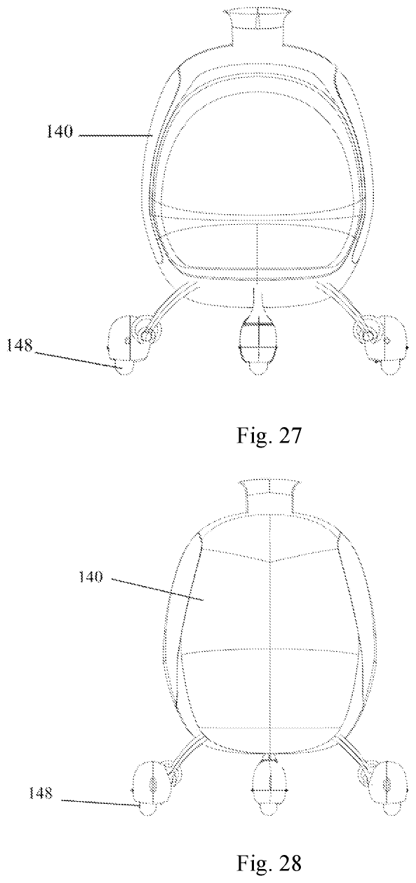

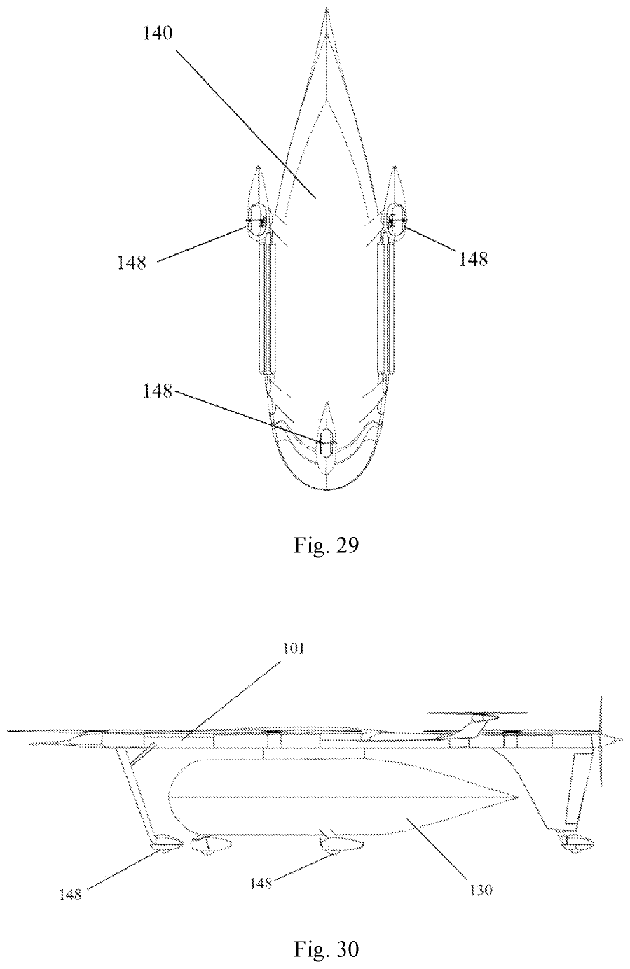

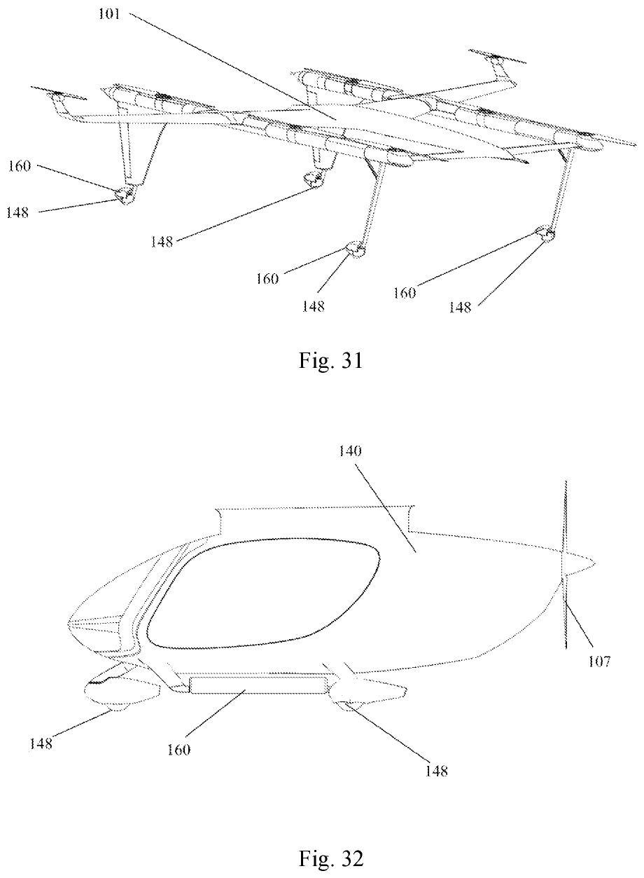

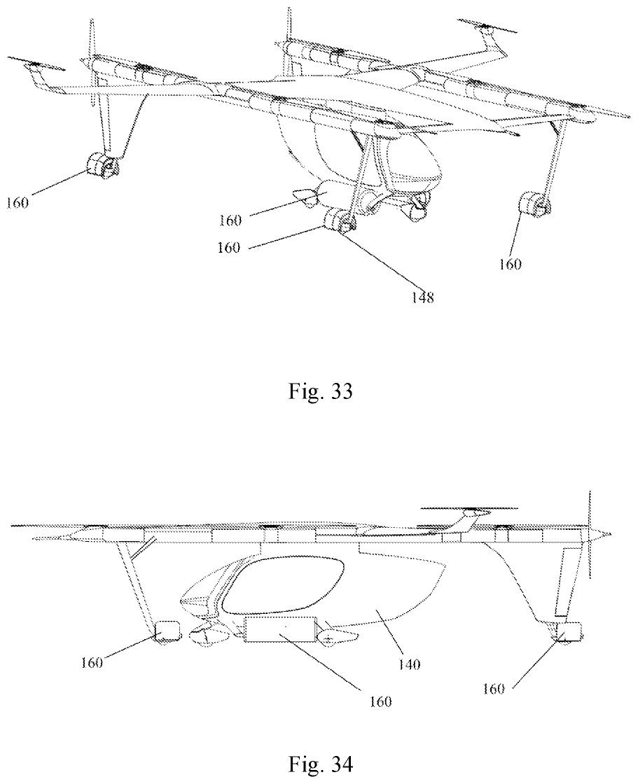

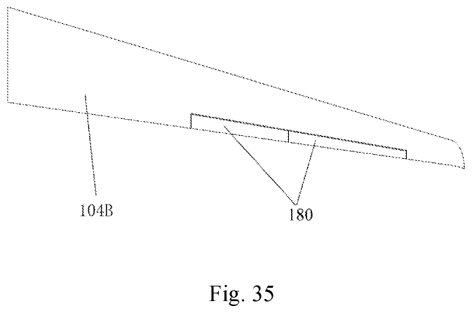

FIG. 1a is a top perspective view of an embodiment of a VTOL UAV system according to one aspect of the embodiment; FIG. 1b is a top perspective view of an embodiment of a VTOL UAV system according to another aspect of the embodiment; FIG. 1c is a top perspective view of an embodiment of a VTOL UAV system according to the other aspect of the embodiment; FIG. 2 is a top rear perspective view of the UAV system of FIG. 1c; FIG. 3 is a side view of the UAV system of FIG. 1c; FIG. 4 is a top perspective view of another embodiment of a VTOL UAV system with a flight platform and a detachable attached cabin according to one aspect of the embodiment; FIG. 5 is a top view of the UAV system of FIG. 4 according to one aspect of the embodiment; FIG. 6 is a front view of the UAV system of FIG. 4 according to one aspect of the embodiment; FIG. 7 is a top perspective view of an embodiment of a VTOL UAV system with a flight platform and a detachable attached cabin according to one aspect of the embodiment; FIG. 8 is a front view of the UAV system of FIG. 7 according to one aspect of the embodiment; FIG. 9 is a rear perspective view of the UAV system of FIG. 7 according to one aspect of the embodiment; FIG. 10 is a side perspective view of the UAV system of FIG. 7 according to one aspect of the embodiment, wherein the passenger cabin is separated from the flight platform and parked on the ground; FIG. 11 is a rear perspective view of the embodiment of FIG. 7 according to one aspect of the embodiment; FIG. 12 is a rear perspective view of another embodiment according to one aspect of the disclosure; FIG. 13 is a side bottom perspective view of another embodiment of a UAV system according to one aspect of the embodiment; FIG. 14 is a perspective view of an embodiment of a UAV system according to another aspect of the embodiment; FIG. 15 is a close-up view of the surrounding area in FIG. 14 according to another aspect of the embodiment; FIG. 16 is a side view of one embodiment of a UAV system according to another aspect of the embodiment; FIG. 17 is a front view of one embodiment of a UAV system according to another aspect of the embodiment; FIG. 18 is a rear view of one embodiment of a UAV system according to another aspect of the embodiment; FIG. 19 is a bottom view of one embodiment of a UAV system according to another aspect of the embodiment; FIG. 20 is a perspective view of another embodiment of a flight platform according to another aspect of the embodiment; FIG. 21 is a side view of another embodiment of a flight platform according to another aspect of the embodiment; FIG. 22 is a front view of another embodiment of a flight platform according to another aspect of the embodiment; FIG. 23 is a rear view of another embodiment of a flight platform according to another aspect of the embodiment; FIG. 24 is a bottom view of another embodiment of a flight platform according to another aspect of the embodiment; FIG. 25 is a side view of another embodiment of a passenger cabin according to another aspect of the embodiment; FIG. 26 is a bottom perspective view of another embodiment of a passenger cabin according to another aspect of the embodiment; FIG. 27 is a front view of another embodiment of a passenger cabin according to another aspect of the embodiment; FIG. 28 is a rear view of another embodiment of a passenger cabin according to another aspect of the embodiment; FIG. 29 is a bottom view of another embodiment of a passenger cabin according to another aspect of the embodiment; FIG. 30 is a side view of another embodiment of a flight platform attached to a cargo hold according to another aspect of the embodiment; FIG. 31 is a perspective view of another embodiment of a flight platform without a propulsion propeller according to another aspect of the embodiment; FIG. 32 is a side view of another embodiment of a passenger cabin having a propulsion propeller according to another aspect of the embodiment; FIG. 33 is a perspective view of another embodiment of a flying UAV system in which six floating devices are inflated; FIG. 34 is a side view of the flying UAV of FIG. 33; FIG. 35 is a diagram showing the configuration of an aileron of a UAV.

FIG. 1a is a top perspective view of an embodiment of a VTOL UAV system according to one aspect of the embodiment. As shown in FIG. 1a, the present embodiment provides a UAV power system, including a propulsion propeller 107, a traction propeller 170 and a propulsion component (not shown in the figure). It is easy to understand that the traction propeller 170 arranged at the front end of the UAV 100 may produce the forward traction force during the rotation of the traction propeller 170 which may tow the UAV 100 forward.

FIG. 1a shows that the propulsion propeller 107 arranged at the rear end of the UAV 100 applies the forward thrust to the UAV 100 during the rotation of the propeller 107 and pushes the UAV 100 to fly forward. In this embodiment, the size of the traction propeller 170 and the propulsion propeller 107 is not limited, and those skilled in the art may set them according to actual needs.

In one possible implementation, the driving component arranged inside the UAV 100 is used to drive the traction propeller 170 and the propulsion propeller 107 to rotate around its own rotation axis. For example, an electric motor may be used as a driving component. There are two motors which are positioned at the front and rear ends of the UAV 100, respectively. The traction propeller 170 and the propulsion propeller 107 are fixedly connected with the output shaft of the motor, respectively. When the output shaft of the motor rotates, the traction propeller 170 or the propulsion propeller 107 can be driven to rotate.

Preferably, the driving component includes an electric motor for driving the propulsion propeller 107 or the traction propeller 170 and a fuel engine for driving the other one of the propulsion propeller 107 or the traction propeller 170. Those skilled in the art can understand that the motor is electrically driven and the fuel engine is driven through fuel combustion. For the motor and the fuel engine, different driving modes may avoid failure due to the same reason. One possible implementation is that the motor is used to drive the propulsion propeller 107. For example, the propulsion propeller 107 is fixedly connected with the output shaft of the motor. When the output shaft of the motor rotates, the propulsion propeller 107 is driven to rotate synchronously. The fuel engine is used to drive the traction propeller 170, that is, the output end of the fuel engine is driven and connected with the traction propeller 170. When the fuel engine is started, the traction propeller 170 is driven to rotate around its rotation axis and generate the traction force. Of course, in another possible implementation, the motor may be used to drive the traction propeller 170 and the fuel engine may be used to drive the propulsion propeller 107.

Those skilled in the art can understand that the electric motor and the fuel engine may be used to drive the propulsion propeller 107 and the traction propeller 170, respectively. Different operation principles of the motor and the fuel engine may avoid the common mode failure, that is, the failure due to the same reason, thereby improving the failure redundancy and reducing the safety deficiency of the common mode failure probability.

FIG. 1a shows that a plurality of lift propellers are arranged above the UAV 100. One possible implementation is that a plurality of lift propellers are driven by an electric motor, wherein each motor is used to drive a lift propeller. The body of the motor is positioned inside the UAV 100, and the lift propeller is fixedly connected with the output shaft of the motor. Of course, in another possible implementation, a fuel engine may also be used to drive a plurality of lift propellers.

Preferably, the rotation axis of the propulsion propeller 107 and the rotation axis of the traction propeller 170 are parallel to the length direction of the UAV 100. It is easy to be understood that the UAV 100 moves along its own length direction during the level flight stage, and the rotation axis of the propulsion propeller 107 and the rotation axis of the traction propeller 170 are set parallel to the length direction of the UAV 100. The force generated when the propulsion propeller 107 or the traction propeller 170 rotates has no component in other directions, which helps the propulsion propeller 107 or the traction propeller 170 to drive the UAV 100 to fly forward.

The UAV 100 may at least include a left main wing 104A and a right main wing 104B; a left front wing 105A and a right front wing 105B; a main body 102 engaged with the left main wing 104A and the right main wing 104B; a left linear support 103A connecting the left main wing 104A with the left front wing 105A; a right linear support 103B connecting the right main wing 104B with the right front wing 105B; a propulsion propeller 107 arranged at the rear end of the main body 102, with its rotation axis parallel to the longitudinal axis of the UAV 100; a traction propeller 170 arranged at the front end of the main body 102, with its rotation axis parallel to the longitudinal axis of the UAV 100. When the UAV 100 is in the level flight stage, at least one of the propulsion propeller 107 and the traction propeller 170 is in the working state, wherein the left linear support has the first group of a plurality of lift propellers 108A, 108B and 108C arranged thereon; wherein the right linear support has the second group of a plurality of lift propellers 108D, 108E and 108F arranged thereon.

The aerial VTOL UAV provided by the disclosure is equipped with a traction propeller and a propulsion propeller, respectively. When either the traction propeller 170 or the propulsion propeller 107 fails, the other may continue to work to enable the UAV 100 to fly forward, thereby improving the failure redundancy and reducing the safety deficiency of common mode failure probability.

Alternatively, as shown in FIG. 1b, the UAV 100 may further include a left caudal fin 191A and a right caudal fin 191B. The left caudal fin 191A is arranged on the upper side of the end of the left linear support 103A, and the right caudal fin 191B is arranged on the upper side of the end of the right linear support 103B. The left additional lift propeller 190A and the right additional lift propeller 190B are arranged at the top ends of the left and right caudal fins 191A and 191B, respectively. The additional lift propellers arranged on the left and right caudal fins result in more compact structure of the whole machine and reduced structural weight, thereby reducing the cruise power and increasing the flight time.

In one embodiment, as shown in FIG. 1b, two vertical stabilizers 106A and 106B may be arranged near the rear end of each linear support 103A and 103B, respectively. Although they are shown pointing downward, there may also be embodiments in which they point upward.

FIG. 1c generally depicts an embodiment of an aerial VTOL UAV 100 with a front wing configuration.

The UAV shown in FIGS. 1a-1c have partially the same structural configuration, and its component characteristics can be flexibly combined. The drawings are only exemplary.

In FIG. 1c, the UAV 100 may have two main wings 104A and 104B as left and right main wings, and two front wings 105A and 105B as left and right ailerons. Two main wings 104A, 104B and two front wings 105A, 105B may be attached to the body 102, wherein the body may be positioned along the central longitudinal line of the UAV 100. There may also be a left linear support 103A arranged parallel to the main body 102, and the left main wing 104A may be connected to the left front wing 105A. Similarly, there may also be a right linear support 103B arranged parallel to the main body 102, and the right main wing 104B may be connected to the right front wing 105B. Among them, the front wing of the UAV mainly controls the flight attitude of the UAV during flight, such as controlling the pitch of the UAV. As the largest wing on both sides of the fuselage, the main wing of the UAV is usually used to generate lift to support the UAV flying in the air, and also plays a certain role in stabilization and control.

In one embodiment, as shown in FIG. 35, the aileron 180 of the UAV may be arranged on the rear side of the main wing 104B, and the number of ailerons may be at least one, preferably two. The aileron has the sheet structure, and it can move up and down to control the roll of the UAV.

In another embodiment, the UAV 100 may not have a front wing configuration. For example, the UAV 100 may have two main wings as left and right main wings, and two ailerons as left and right ailerons, all of which are joined together to form a flight platform.

The left and right linear supports 103A, 103B are expected to improve the structural integrity of the UAV 100. In other embodiments, the left and right linear supports 103A and 103B may accommodate driving electric motors (not shown) driving each lift propeller 108A, 108B, 108C, 108D, 108E, 108F. Therefore, the left and right linear supports 103A and 103B may be used to fix the lift propellers and reduce the use of UAV components. While simplifying the structural components of the UAV, the left and right linear supports 103A and 103B can also improve the overall strength of the UAV because they are connected with two front wings and two main wings. As will be disclosed later, the left and right linear supports 103A and 103B may also accommodate folding legs 111, each folding leg retractable into the left and right linear supports 103A and 103B.

In one embodiment, the left and right linear supports 103A and 103B are attached to the distal ends of the left and right front wings 105A and 105B, respectively. In another embodiment, the left and right linear supports 103A and 103B extend beyond the front wings 105A and 105B.

In one embodiment, the left and right linear supports 103A and 103B are attached near the middle portions of the left and right main wings 104A and 104B, respectively. In another embodiment, the left and right linear supports 103A and 103B extend in a rearward direction beyond the main wings 104A and 104B.

The left linear support 103A is expected to be relatively narrow in diameter and may have the first group of a plurality of lift propellers 108A, 108B and 108C arranged on the top side, bottom side, or both of the left linear support 103A. In a possible embodiment, these lift propellers 108A, 108B and 108C may be driven by a low profile electric motor arranged in the hollow interior of the left linear support 103A. In the embodiment shown in FIG. 1c, the lift propellers 108A, 108B and 108C are only arranged on the top side of the left linear support 103A. It should be noted that the number of lift propellers shown in the figure is only for illustrative purposes. The disclosure does not limit the number. In practice, the number of lift propellers may be increased or decreased according to demand. Similarly, the right linear support 103B is expected to be relatively narrow in diameter and may have the second group of a plurality of lift propellers 108D, 108E and 108F arranged on the top side, bottom side or both of the right linear support 103B. In one possible embodiment, these lift propellers 108D, 108E, and 108F may be driven by a low profile motor arranged in the hollow interior of the right linear support. In the embodiment shown in FIG. 1c, the lift propellers 108D, 108E and 108F are only arranged on the top side of the right linear support 103B. It should be noted that the number of lift propellers shown in the figure is only for illustrative purposes. The disclosure does not limit the number. In practice, the number of lift propellers may be increased or decreased according to demand.

In one embodiment, the UAV 100 may have at least one propulsion propeller 107 to push the UAV 100 in the forward direction. In one embodiment shown in FIG. 1c, there may be two propulsion propellers 107A and 107B. The two propulsion propellers 107A and 107B may be arranged on the rear and distal ends of the linear supports 103A and 103B, respectively. In the embodiment shown in FIGS. 1a and 1b, there may be a propulsion propeller 107. A propulsion propeller 107 may be arranged at the rear end of the main body 102, with its rotation axis parallel to the longitudinal axis of the UAV 100.

The UAV 100 may have at least one traction propeller 170 to pull the UAV 100 in a forward direction. In the embodiments shown in FIGS. 1a and 1b, the traction propeller 170 may be arranged at the front end of the main body 102, with its rotation axis parallel to the longitudinal axis of the UAV 100.

As described above, the UAV 100 is configured with multiple groups of different types of propellers, including the first group of a plurality of lift propellers, the second group of a plurality of lift propellers, the propulsion propeller and the traction propeller. When in use, a plurality of groups of lift motors maybe used to drive a plurality of lift propellers, the head propulsion motor maybe used to drive the traction propeller, and the fuel propulsion engine may be used to drive the propulsion propeller. For example, a plurality of groups of lift motors and head propulsion motors may be supplied with energy by the same main power supply bus bar, and the fuel propulsion engine may be supplied with energy by a separate fuel circuit. Therefore, multi-mode power configuration in the above way may be used to improve the failure redundancy and the safety deficiency of common mode failure probability. In case of emergency, when the power provided by the propulsion motor is insufficient (including motor failure), the fault-free power provides thrust output for mutual backup to offer the safety of the aerial UAV.

Further, the fuel engine of the existing heavy-duty VTOL UAV with pure electric power has too much noise, which has a great impact on the surrounding areas in the low altitude conversion stage, easily causing residents' complaints. According to the technical solution provided by the disclosure, in one embodiment, either the propulsion propeller 107 or the traction propeller 170 is driven by an electric motor and the other is driven by a fuel engine. For example, the propulsion propeller 107 may be driven by a fuel engine, so the traction propeller 170 may be driven by an electric motor. Generally speaking, the operating noise of the fuel engine (or internal combustion engine) is about 110 dB, and the noise of the motor under the same output power is about 85 dB, and the noise energy of the fuel engine is about 300 times that of the motor. Therefore, according to the solution of the disclosure, in one embodiment, when the aerial UAV is in the low altitude conversion mode or cruise mode, or when the aerial UAV is in the low altitude conversion stage or cruise stage, the fuel engine may be in the idle state. In such case, the noise of the fuel engine is small because the motor mainly provides horizontal thrust for the traction propeller. Therefore, at this time, the operating state of the motor of the aerial UAV has less noise impact on the surrounding area.

In addition, because the energy density of fuel is much higher than that of the current lithium battery technology and the traffic load is reduced, the adoption of fuel engine to drive the propeller may effectively break through the level flight endurance of pure electric UAV and improve the traffic load under the same maximum takeoff weight.

Further, in one embodiment, the aerial VTOL UAV may also include a starting motor, which is connected to the fuel engine through a physically driven clutch device. The rotation of the output shaft of the starting motor drives the shaft ring gear of the fuel engine to rotate, so as to start the fuel engine. Those skilled in the art can understand that the starting of the fuel engine requires an initial force to rotate the shaft ring gear of the fuel engine, set a starting motor, and use the starting motor to drive the shafting of the fuel engine to rotate, thereby starting the fuel engine. Those skilled in the art may use the starting motor to start the fuel engine by supplying power to the starting motor.

The clutch device may provide a physical connection between the starting motor and the fuel engine. For example, the input end of the clutch device is driven and connected with the output end of the starting motor, the output end of the clutch device is fixedly connected with the output gear, and the clutch device is used to drive the output gear to move between the first position and the second position along the axial direction of the output gear; when the output gear is in the first position, the output gear is engaged with the shafting ring gear of the fuel engine; when the output gear is in the second position, the output gear is separated from the shaft ring gear of the fuel engine. In this embodiment, the specific structure of the clutch device is not limited. Those skilled in the art may set it according to the actual needs. For example, the shaft may also be used as the clutch device to realize the connection or separation of the starting motor and the fuel engine by moving the shaft along its own axis. Of course, the existing clutch device on the market may also be selected. By providing a clutch device between the starting motor and the fuel engine, the connection state between the starting motor and the fuel engine may be controlled more flexibly, thereby providing guarantee for the improved endurance of the aerial UAV.

In one possible implementation, the UAV 100 is also provided with a power supply bus bar, which is positioned inside the main body 102. The power supply bus bar is electrically connected with the starting motor and the motor, respectively, to supply power to the starting motor and the motor. It is easy to be understood that the power supply bus bar is a conductive connecting part. The starting motor and the electric motor are electrically connected with the power supply bus bar, respectively. At the same time, the power supply bus bar is also connected with a power supply so that the power supply can supply power to the starting motor and the motor through the power supply bus bar.

In one embodiment, the starting motor can remain mechanically engaged with the fuel engine during the operation of the fuel engine, so the starting motor may act as a generator. Specifically, the starting motor is powered by the main power supply bus bar or the emergency power supply bus bar during the start of the fuel engine. After the fuel engine is started, the clutch may be in the state of OFF or HOLD. If the physical connection between the fuel engine and the starting motor is maintained (i.e. the clutch device is in the state of HOLD), at this time, the starting motor, as a generator driven by the fuel engine, may supply power to the main power supply bus bar or emergency power supply bus bar, so as to further improve the endurance capacity of the UAV.

In one embodiment, the fuel engine may be a standard vehicle gasoline piston aero-engine to reduce the maintenance cycle and use cost.

In one embodiment, it may also include detachable cabins 130 and 140 attached to the bottom surface of the aerial UAV, which are passenger cabin 130 or cargo hold 140. Through the above setting method, the structure of the UAV may be flexibly adjusted. According to the actual situation, the cabin may be installed when necessary and disassembled when unnecessary so as to flexibly use the UAV in response to different needs and improve its adaptability.

In one embodiment, both the main wing and aileron of the UAV 100 may be configured as a front wing configuration.

In another embodiment, such as the embodiment shown in FIG. 31, the flight platform 101 may not have a propulsion propeller. In such an embodiment, the flight platform 101 may be attached to a passenger cabin or cargo hold on which a propulsion propeller is provided. FIG. 32 shows an embodiment of a cabin having a propulsion propeller arranged at its rear end. When the passenger cabin is attached to the flight platform 101 of FIG. 31, the propulsion propeller is pushed forward to the flight platform 101.

Two vertical stabilizers 106A and 106B may be arranged near the rear end of each of linear support 103A and 103b, respectively. Although they are shown pointing downward, there may also be embodiments in which they point upward.

In another embodiment, each of main wings 104A and 104B may have additional lift propellers 109A and 109B provided at its distal end, respectively. This may be achieved by providing wingtip vertical stabilizers 110A and 110B at the distal ends of the main wings 104A and 104B, respectively, and having lift propellers 109A and 109B arranged at the upper tip of each wingtip vertical stabilizer 110A and 110B. These wingtip lift propellers 109A and 109B may be relatively smaller than the lift propellers provided on the linear supports 103A and 103B. Alternatively, as shown in FIG. 1b, the additional lift propellers 190A and 190B may be arranged on the distal top end of the left and right linear supports 103A and 103B.

These wingtip lift propellers 109A and 109B may be used to control the rolling of the UAV 100 in an effective and efficient manner. These wingtip lift propellers 109A and 109B are positioned at the farthest position away from the central axis of the UAV 100, which is effective in adjusting the rolling of the UAV 100, and may be achieved with a diameter smaller than that of other lift propellers.

As further shown in FIG. 1c, there is a cabin 130 normally attached below the main body 102 of the UAV 100.

Now referring to the details of FIG. 2, the UAV 100 is expected to use any type of landing gear. In one embodiment, the UAV 100 may have four single leaf springs 112A, 112B, 112C and 112D as its landing gear. The first two single leaf springs 112A and 112C are arranged on the distal ends of the folding legs 111A and 111B, respectively. During flight, the folding legs 111A and 111B can be retracted into the internal space of the left and right linear supports 103A and 103B, respectively.

The two left single leaf springs 112B and 112D at the rear are expected to be arranged at the distal ends of the bottom of the vertical stabilizers 106A and 106B, respectively. The expected single leaf springs 112A, 112B, 112C and 112D may be made of suitable materials to provide sufficient elasticity and integrity, including natural and synthetic polymers, various metals and metal alloys, natural materials, textile fibers, and all reasonable combinations thereof. In one embodiment, carbon fibers are adopted.

Now turning to FIG. 3, it shows a cabin as cargo hold 130. The cargo hold 130 may have single leaf springs 135A, 135B, 135C and 135D as its landing gear. Alternatively, it may have other types of landing gear, such as rails, legs, and wheels.

In the intended embodiment, the cargo hold 130 may be disassembled from the rest of the UAV 100. The rest of the UAV may be referred to as flight platform 101. The flight platform 101 may fly without a cabin, and it may carry different cabins interchangeably. As will be described later, the flight platform 101 may also carry a passenger cabin.

In the example shown, all cabins 130 and 140 are carried below the flight platform 101. It is expected that the cabins 130 and 140 are loaded on the ground, and the loading process may be completed before or after the flight platform 101 is attached to the cabins 130 and 140.

FIG. 5 shows a top view of the flight platform 101. It may have a substantially flat structure and can carry a load below or above it. During high-speed flight, all six lift propellers 108A, 108B, 108C, 108D, 108E and 108F may be locked in place so that each left is parallel to the main body 102.

FIG. 5 shows an embodiment of the flight platform 101 wherein the length of the front wings 105A and 105B is not longer than half the length of each of main wings 104A and 104B.

FIG. 6 generally depicts a front view of the flight platform 101 with a detachably attached cargo hold 130. Whether it is cargo hold 130, passenger cabin 140 or any other type of load, it is particularly expected that there may be an energy storage unit 150 provided in the main body 102 of the flight platform. The stored energy may be used to power other components of the flight platform, such as lift propellers 108A, 108B, 108C and 108D and propulsion propellers 107A and 107B. The stored energy may be electricity, and the storage unit is a battery. In another embodiment, the energy storage 150 may be used to power accessories in cabins 130 and 140.

The battery 150 may also be provided in other parts of the flight platform 101, such as in linear supports 103A and 103B.

Alternatively or optionally, there may be an energy storage unit 155 provided in the cabins 130 and 140. The energy stored in the storage unit 155 may be used to power the lift propellers 108A, 108B, 108C and 108D and the propulsion propellers 107A and 107B. The stored energy may be electricity, and the storage unit is a battery. By having an energy storage unit 155 in the cabins 130 and 140, the flight platform 101 will have a supplementary energy source whenever the flight platform 101 carries new cabins 130 and 140. The flight platform 101 itself may be an emergency energy storage or a small capacity battery 150 to provide power to the flight platform 101 in a short time when the flight platform 101 flies without cabins 130 and 140. In one embodiment, the main power supply of the flight platform 101 comes from the battery 150 positioned in the cabins 130 and 140. In this way, when the old cabins 130 and 140 are replaced with the new cabins 130 and 140 in the flight platform 101, the flight platform 101 or the whole VTOL UAV system 100 will have a fully charged energy source. This is a useful method, and there is no need for VTOL UAV to charge itself. In a preferred embodiment, the flight platform 101 can work/fly continuously for hours or even days, pick up the cargo hold/passenger cabin, and unload the cargo hold/passenger cabin without stopping to charge its battery.

Now, referring to the details of FIG. 7, a passenger cabin 150 is provided. The passenger cabin 150 may use any type of landing gear, such as rigid legs 145A, 145B, 145C, and 145D as shown in the figure.

FIG. 10 generally depicts an aspect of the disclosure, wherein the cabin (whether cargo hold or passenger cabin) is detachable. Here, the cabin 140 may be selectively separated from the flight platform 101. The engagement and disengagement between the flight platform 101 and the cabin 140 may be performed autonomously by a computer and/or other sensors and computing devices (without simultaneous user intervention). Alternatively or optionally, the user may actively control and guide the engagement and disengagement between the flight platform 101 and the cabin 140.

As ordinary people skilled in the art will recognize, various types of engagement mechanisms 147 may be used to secure the cabin 140 to the flight platform 101. For example, the engagement mechanism may be mechanical latch, magnetic latch, track and groove, or any combination of known engagement methods.

It is important to understand that, in addition to having two propulsion propellers 107A and 107B (as shown in FIG. 11), alternatively or optionally, there may be a central propulsion propeller 117 connected to the rear end of the body 102 (as shown in FIG. 12). As shown in FIG. 12, the central push propeller 117 is engaged to the rear end of the main body 102 through the vertical expander 116. The vertical expander 116 may be any structure of any shape to be physically engaged with the propulsion propeller 117 so that the rotation center of the propulsion propeller 117 deviates vertically from the main body 102. In another embodiment, the propulsion propeller 117 deviates vertically from the main body 102 so that the rotation center of the propulsion propeller 117 is vertically flush with the rear of the cabin 140. In another embodiment, the propulsion propeller 117 is vertically flush with the top of the cabin 140. In another embodiment, the propulsion propeller 117 is vertically flush with the middle of the cabin 140. In a further embodiment, the propulsion propeller 117 is vertically flush with the bottom of the cabin 140.

What is not shown in any figure of the embodiment is that the propulsion propellers 107A and 107B are not provided at the ends of the linear supports 103A and 103B, respectively. On the contrary, only one propulsion propeller 117 is engaged with the rear end of the main body 102.

It may be also envisaged that each of linear supports 103A and 103B may include more than three lift propellers by providing longer linear supports to accommodate more lift propellers, by using lift propellers of smaller diameter, or by arranging lift propellers on both the top and bottom sides of the linear support. FIG. 13 shows an embodiment wherein two additional lift propellers 108G and 108H are arranged at the front end of the bottom of the linear supports 103A and 103B.

Although the propulsion propellers 107A and 107B have been shown in the previous figure to be positioned at the rear distal end of the linear supports 103A and 103B, it is particularly expected that these propulsion propellers 107A and 107B may be arranged at a horizontal plane lower than the main wings 104A and 104B, such as those shown in FIG. 13. On one hand, these propulsion propellers 107A and 107B may be arranged at a level substantially equal to the cabins 130 and 140 carried by the flight platform. On the other, these propulsion propellers 107A and 107B may be arranged in the middle of the vertical stabilizers 106A and 106B. One expected reason for reducing the arrangement of propulsion propellers 107A and 107B is to minimize the head dipping effect during flight, which may be caused by the aerodynamic effect caused by cabins 130 and 140.

FIGS. 14 to 30 show an embodiment wherein the flight platform 101 or the cabins 130 and 140 or both may have an electric wheel 148 attached thereto. In the embodiment of FIG. 14, the flight platform 101 has an electric wheel 148; the cabins 130 and 140 also have electric wheels. Now referring to the embodiment of FIG. 15, a single electric wheel unit 148 may have an electric motor enclosed in the housing 149, and the electric motor may be driven by power supplied by the energy storage unit 150 provided in the cabins 130 and 140.

It is envisaged that the electric wheel 148 may move the flight platform 101 and the cabin 130 on the ground when they are parked on the ground. This allows the cabin 130 or 140 to move away from the flight platform 101 and allows the other one of cabin 130 or 140 to move itself to the flight platform 101 for engagement.

Alternatively, this may allow the flight platform 101 to move away from the cabin 130 and towards another cabin for engagement. In one embodiment, each cabin 130, 140 may have an energy storage unit 155 so that when the flight platform 101 is engaged with the new and fully charged cabins 130, 140, the flight platform 101 will basically supplement its energy source.

In some embodiments of the disclosed unmanned aircraft system, at least one floating device 160 may be provided, which is engaged with at least any of the cargo hold 130, the passenger cabin 140 and the flight platform 101. The floating device may be of a type that needs to be actuated, that is, actively inflated with gas or material when required. In other words, in this particular embodiment, the floating device 160 may remain in the deflated state and expand only when certain conditions trigger inflation. For example, the floating device 160 may automatically inflate during an emergency landing; it may inflate automatically when landing on water; when any landing gear fails in some aspect, it may be inflated.

Many known types of inflation mechanisms or airbag mechanisms may be implemented to achieve the needs and configuration of the disclosed floating device 160. The expected floating device 160 may be of a type that can be reused, re-inflated and re-deflated repeatedly. The intended floating device 160 may also be disposable only.

Alternatively or optionally, the inflation behavior may be activated by the user. For example, when the operator of the UAV system determines that the floating device 160 needs to be inflated, he or she may send a signal to start inflation.

In some embodiments, it should be noted that the floating device 160 does not need to have an electric wheel 148. In other embodiments, the floating device 160 is part of the housing of the electric wheel 148.

Referring to FIG. 26 as an example, the passenger cabin 140 may have an extended floating device 160 arranged on either side of the cabin 140, which may be used as a waterborne landing gear. In FIG. 26, these floating devices 160 are shown as deflated. FIG. 32 shows a side view of the deflated floating device 160. As shown in FIGS. 33 and 34, the floating device 160 engaged with the passenger cabin 140 is shown as inflated.

Referring to FIG. 31 as another example, the flight platform 101 may have four floating devices 160 arranged on the top of each of the four electric wheels 148. These floating devices 160 may alternatively be attached to or close to the electric wheel 148 at other positions. In FIG. 31, these floating devices 160 engaged with the electric wheel 148 are shown as deflated. FIGS. 33 and 34 show an inflated floating device 160 of the flight platform 101.

The disclosure also provides a system for minimizing the failure of an aerial UAV, comprising a left main wing and a right main wing; a left aileron and a right aileron; a main body engaged with the left main wing and the right main wing; a left linear support connecting the left main wing with the left aileron; a right linear support connecting the right main wing with the right aileron; the propulsion propeller arranged at the rear end of the main body, with its rotation axis parallel to the longitudinal axis of the UAV; the traction propeller arranged at the front end of the main body, with its rotation axis parallel to the longitudinal axis of the UAV; the first group of a plurality of lift propellers arranged on the left linear support; the second group of a plurality of lift propellers arranged on the right linear support; a fuel engine configured to drive at least one of a plurality of lift propellers, propulsion propellers and traction propellers; and an electric motor configured to drive at least of one of a plurality of lift propellers, propulsion propellers and traction propellers. For the specific configuration, reference may be also to FIG. 1a, wherein the fuel engine and motor are not shown, the specific configuration of which may be flexibly set, provided that the driving function can be implemented.

In an embodiment of the disclosure, the propelling propeller 107 can be driven by a fuel engine. When the fuel engine is used for driving, because the energy density of the fuel is much higher than that of current lithium battery technology and the traffic load is reduced, the adoption of a group of fuel thrust engines may effectively break through the level flight endurance of the pure electric UAV and improve the traffic load under the same maximum takeoff weight.

In an embodiment of the disclosure, it can also include a starting motor connected with the fuel engine so that the fuel engine and the starting motor can cooperate synchronously. The two are coupled with each other through a physically driven clutch device. When the fuel engine is started, the starting motor will supply power through the main power supply bus bar or emergency power supply bus bar. After the fuel engine is started, the clutch device may be in the state of OFF or HOLD, so as to flexibly select whether to be powered by the starting motor.

In an embodiment of the disclosure, it may also include a generator connected with the fuel engine, which may supply power to the main power supply bus bar or emergency power supply bus bar, so as to further improve the endurance capacity of the UAV.

In an embodiment of the disclosure, during flight, the starting motor and the fuel engine may be mechanically connected for power generation, which is conducive to improving the flight time.

In an embodiment of the disclosure, it may also include a cabin detachably attached to the bottom surface of the aerial UAV, which is a passenger cabin or cargo hold. Through the above setting method, the structure of the UAV may be flexibly adjusted. According to the actual situation, the cabin may be installed when necessary and disassembled when unnecessary so as to flexibly use the UAV in response to different needs and improve its adaptability.

The system for minimizing the failure of the aerial UAV provided by the disclosure uses multi-mode power configuration to improve the failure redundancy and thus minimize the failure of the aerial UAV.

Many changes and modifications can be made by those skilled in the art without departing from the spirit and scope of the disclosed embodiments. Therefore, it must be understood that the illustrated embodiments are proposed only for the purpose of example and should not be regarded as limiting the embodiments defined by the attached technical solution. For example, despite the fact that the elements of the technical solution are presented below in some combination, it must be clearly understood that the embodiment includes other combinations of fewer, more or different elements, which are disclosed herein, even if such combinations are not limited initially.

Therefore, specific embodiments and applications of VTOL flight platforms with interchangeable cabins have been disclosed. However, it will be apparent to those skilled in the art that more modifications other than those already described are possible without departing from the concepts disclosed herein. Therefore, in addition to the spirit of the attached technical scheme, the disclosed embodiments are unrestricted. In addition, when interpreting the specifications and technical solution, all terms shall be interpreted in the manner as extensive as possible that is consistent with the context. In particular, the terms “include” and “contain” should be interpreted as referring to an element, component or step in a non-exclusive manner, indicating that the referenced element, component or step may exist, or be utilized, or be combined with other elements, components or steps not explicitly referenced. Non-substantive changes in the claimed subject matter known now or expected later to be seen by those skilled in the art are clearly expected to be equivalent within the scope of the technical solution. Therefore, obvious substitutions now or hereafter known to those of ordinary people skilled in the art are defined as being within the scope of the defined elements. Therefore, the technical solution should be understood as including the contents specifically explained and described above, the contents that are conceptually equivalent, the contents that can be obviously replaced, and the contents that basically include the basic idea of the embodiment. In addition, in the case where the specifications and the technical solution involve at least one element selected from the group consisting of A, B, C . . . and N, the text should be interpreted as requiring at least one element in the group to include N, rather than A plus N, or B plus N, etc.

1. A UAV power system, which is characterized in that:
The propulsion propeller, which is arranged at the rear end of the UAV;
The traction propeller, which is arranged at the front end of the UAV;
Either the traction propeller or the propulsion propeller is the main propeller, while the other is the backup one. When the UAV is in the level flight stage, at least one of the traction propeller and the propulsion propeller is in the working state;
And the driving component, which is used to drive the propulsion propeller and the traction propeller.

2. The UAV power system according to claim 1, which is characterized in that the driving component comprises an electric motor and a fuel engine, the electric motor is used to drive the propulsion propeller or the traction propeller, and the fuel engine is used to drive the other one of the propulsion propeller or the traction propeller.

3. The UAV power system according to claim 2, which is characterized in that it also comprises a plurality of lift propellers, and the lift propellers are driven by the electric motor or the fuel engine.

4. The UAV power system according to claim 3, which is characterized in that the rotation axis of the propulsion propeller is parallel to the length direction of the UAV, and the rotation axis of the traction propeller is parallel to the length direction of the UAV; the rotation axis of the lift propeller is arranged in a vertical direction.

5. A UAV which is characterized by comprising:
Left main wing and right main wing;
Left front wing and right front wing;
A main body, which is engaged with the left main wing and the right main wing;
The left linear support connecting the left main wing with the left front wing, the left linear support having the first group of a plurality of lift propellers arranged thereon;
The right linear support connecting the right main wing with the right front wing, the right linear support having the second group of a plurality of lift propellers arranged thereon;
The propulsion propeller arranged at the rear end of the main body, with its rotation axis parallel to the longitudinal axis of the UAV;
The traction propeller arranged at the front end of the main body, with its rotation axis parallel to the longitudinal axis of the UAV;
When the UAV is in the level flight stage, at least the propulsion propeller or the traction propeller is in the working state.

6. The UAV according to claim 5, which is characterized in that either the propulsion propeller or the traction propeller is driven by an electric motor and the other is driven by a fuel engine.

7. The UAV according to claim 6, which is characterized in that the propulsion propeller is driven by the fuel engine.

8. The UAV according to claim 7, which is characterized in that when the aerial UAV is in low altitude conversion mode or cruise mode, the fuel engine is in idle state.

9. The UAV according to claim 7, which is characterized in that it further comprises a starting motor, which is connected to the fuel engine through a physically driven clutch device.

10. The UAV according to claim 9, which is characterized in that the input end of the clutch device is driven and connected with the output end of the starting motor, the output end of the clutch device is fixedly connected with the output gear, and the clutch device is used to drive the output gear to move between the first position and the second position along the axial direction of the output gear; when the output gear is in the first position, the output gear is engaged with the shaft ring gear of the fuel engine; when the output gear is in the second position, the output gear is separated from the shaft ring gear of the fuel engine.

11. The UAV according to claim 9, which is characterized in that during the operation of the fuel engine, the starting motor remains mechanically engaged with the fuel engine to act as a generator.

12. The UAV according to claim 11, which is characterized in that it also comprises a power supply bus bar, the power supply bus bar is positioned inside the main body, and the power supply bus bar is electrically connected with the starting motor and the electric motor, respectively, to supply power to the starting motor and the motor.

13. The UAV according to claim 7, is characterized in that it further comprises a detachable cabin attached to the bottom surface of the aerial UAV.

14. The UAV according to claim 13, which is characterized in that the cabin is a passenger cabin or cargo hold.

15. The UAV according to claim 7, which is characterized in that the fuel engine is a vehicle gasoline piston aero-engine.

16. A system for minimizing UAV failure, which is characterized by comprising:
Left main wing and right main wing;
Left front wing and right front wing;
The main body engaged with the left main wing and the right main wing;
The left linear support connecting the left main wing with the left front wing;
The right linear support connecting the right main wing with the right front wing;
The propulsion propeller arranged at the rear end of the main body, with its rotation axis parallel to the longitudinal axis of the UAV;
The traction propeller arranged at the front end of the main body, with its rotation axis parallel to the longitudinal axis of the UAV;
The first group of a plurality of lift propellers arranged on the left linear support;
The second group of a plurality of lift propellers arranged on the right linear support;
The fuel engine configured to drive at least one of a plurality of lift propellers, the propulsion propeller and the traction propeller; and
The electric motor configured to drive at least one from a plurality of lift propellers, the propulsion propeller and the traction propeller.

17. The system for minimizing UAV failure according to claim 16, which is characterized in that the propulsion propeller is driven by the fuel engine.

18. The system for minimizing UAV failure according to claim 17, which is characterized in that it also includes a starting motor engaged with the fuel engine.

19. The system for minimizing UAV failure according to claim 18, which is characterized in that it also includes a generator engaged with the fuel engine.

20. The system for minimizing UAV failure according to claim 18, which is characterized in that the starting motor remains mechanically engaged with the fuel engine for power generation during flight.

21. The system for minimizing UAV failure according to claim 18, which is characterized in that it also includes a cabin detachably attached to the bottom surface of the aerial UAV.

22. The system for minimizing UAV failure according to claim 21, which is characterized in that the cabin is a passenger cabin or cargo hold.
